(19) United States
(12) Patent Application Publication
(10) Pub. No.: US 2016/0140942 A1
(43) Pub. Date: May 19, 2016

(54) Recordernizer

(71) Applicant: Peter Rivers, Pittsburgh, PA (US)

(72) Inventor: Peter Rivers, Pittsburgh, PA (US)

(21) Appl. No.: 14/547,151

(22) Filed: Nov. 19, 2014

(30) Foreign Application Priority Data
Nov. 19, 2014 (US) 14547151

(51) Int. Cl. G10G 7/00

(52) U.S. Cl. CPC G10G 7/005

(57) ABSTRACT

The Recordernizer is a storage/organizing device for soprano recorder woodwind instruments. It holds 20 recorders. The Recordernizer is intended to be used by music teachers or other groups/organizations that need a quick, efficient and organized way to store, distribute and transport multiple recorders. It is made of oak wood, however, it can be made of synthetic materials like plastic. It requires very little assembly.

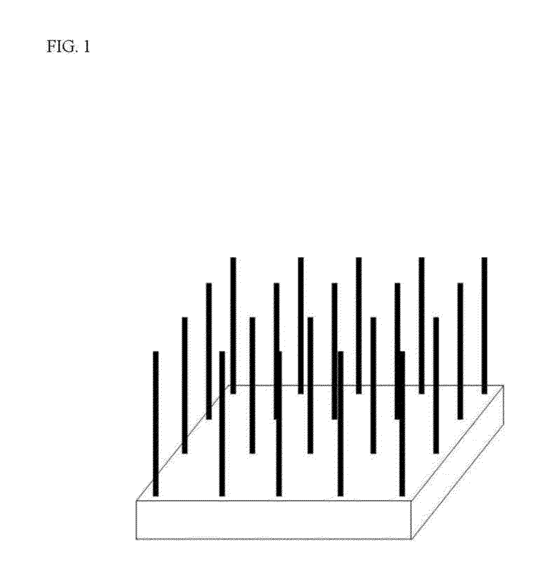

### FIG. 1

FIG. 1 Sequence Listing and Title of invention

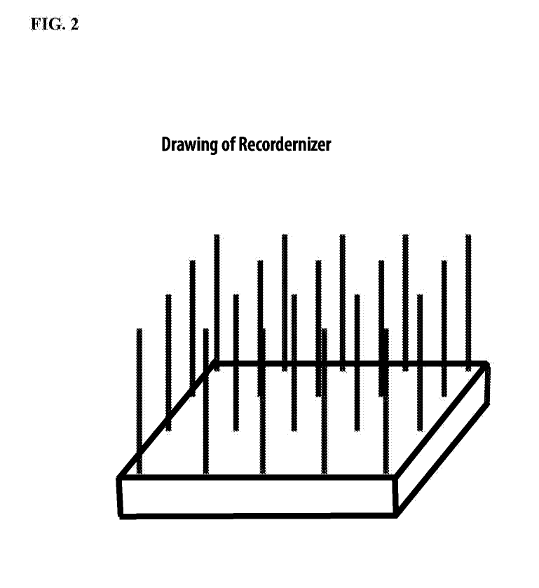

FIG. 2 Drawing of recordernizer

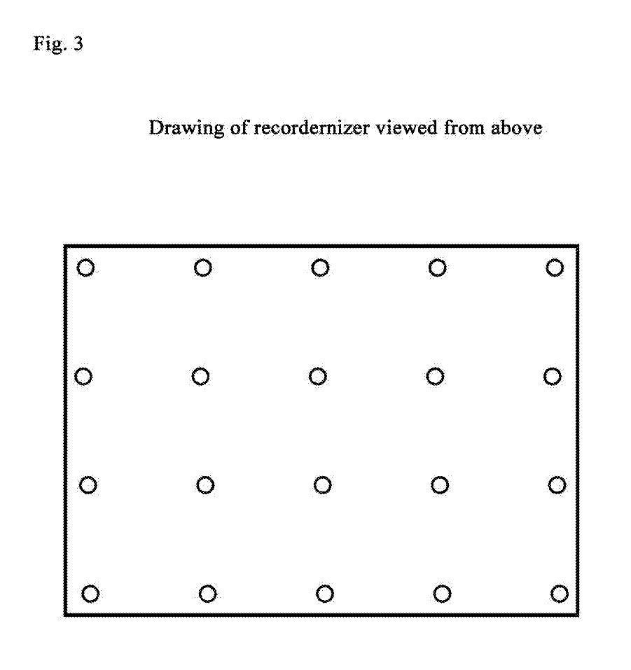

FIG. 3 Drawing of recordernizer with markings viewed from above,

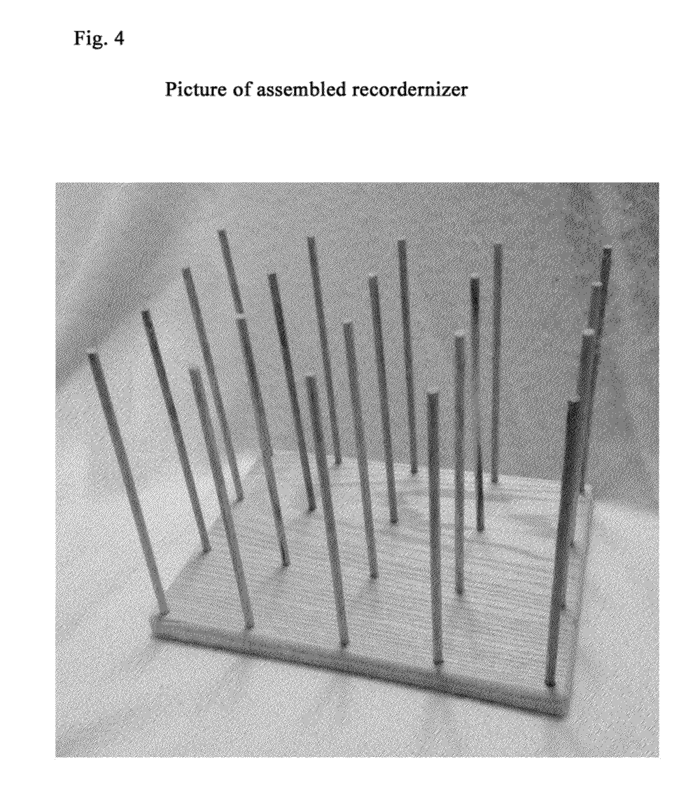

FIG. 4 Picture of assembled recordernizer

FIG. 5 Picture of recordernizer with recorders

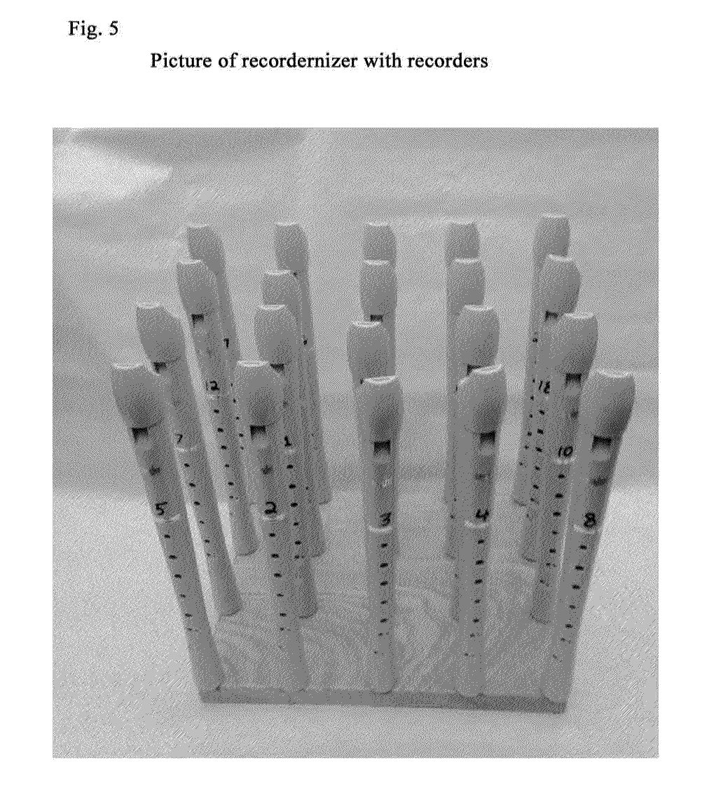

FIG. 6 Detailed description.

FIG. 7 Claims

### FIG. 6

The Recordernizer is a storage/organizing device for soprano recorder woodwind instruments. It holds 20 recorders. The Recordernizer is intended to be used by music teacher's or other groups/organizations that need a quick, efficient and organized way to store (sanitarily), distribute and transport multiple recorders.

It is made of oak wood (board), however, it can be made of synthetic materials like plastic. Oak was chosen because the weight of the board (including the wooden dowels is 2½ lbs) ensures that the device does not easily topple due to uneven distribution of recorders on the board. Also, oak wood keeps the cost down. Manufacturability is efficient and is visually aesthetically pleasing. The board is at least ¾″×9⅛″×12″ 20 17/64″ diameter holes are drilled ⅗″ deep to accommodate ¼″ wood dowels. Periodically, wood putty is use to repair holes that protrude through the board. Since the wooden, dowels are inconsistent in diameter, I use several drill bit sizes in 1/64″ increments. All top edges of the board are rounded over with a router. The bottom edges are rounded over with a router and or belt sander. Before polyurethane is applied, the board is sanded with a belt and or palm sander.

Finally, the 9″ dowels are select and pre-fitted into the holes to ensure proper fit. The dowels, need to fit in the holes securely without leaning to the point that the recorders would touch. Ideally, the board is designed so the dowel can easily be removed. However, the user can select various adhesive solutions to meet their needs. It requires very little assembly. Dowels are to be placed in the holes and aligned in straight rows and columns. Glue can be used to ensure that the dowels do not lean of move out of alignment.

1. The Recordernizer is a storage/organizing device for soprano recorder woodwind instruments, it holds 20 recorders, it is constructed with a rectangular wooden board and (20), (9) inch wooden dowels, the Recordernizer is intended to be used by music teachers or other groups/organizations that need a quick, efficient and organized way to store distribute and transport multiple recorders; i request a patent to grant me the rights to manufacture, market/sell and distribute the “Recordernizer”; The Recordernizer is not available in stores and serves a good purpose.
